(19) United States
(12) Patent Application Publication
(10) Pub. No.: US 2018/0052948 A1
(43) Pub. Date: Feb. 22, 2018

(54) ANALYSIS MESH MANUFACTURING EQUIPMENT AND METHOD

(71) Applicant: Hitachi, Ltd., Tokyo (JP)

(72) Inventors: Makoto ONODERA, Tokyo (JP); Masayuki HARIYA, Tokyo (JP); Chikara KONGOU, Tokyo (JP); Masaki SHINTANI, Tokyo (JP); He QI, Tokyo (JP)

(21) Appl. No.: 15/658,605

(22) Filed: Jul. 25, 2017

(30) Foreign Application Priority Data
Aug. 22, 2016 (JP) 2016-161668

(51) Int. Cl. G06F 17/50

(52) U.S. Cl. CPC G06F 17/50

(57) ABSTRACT

A mesh is manufactured in consideration of the differences between the specification of the mesh to be manufactured for each portion to be analyzed, the difficulty in defining the mesh specification, and the response to the change in the mesh specification. Analysis mesh manufacturing equipment has first means for registering, as an uncorrected sample, a combination of partial mesh data for a correction examining portion and CAD data associated therewith to a mesh correcting sample database, second means for storing mesh data and CAD data that are to be inspected, third means for retrieving, with respect to the mesh data and the CAD data that are to be inspected, a partial mesh that is similar to the mesh data and the CAD data of the uncorrected sample that are registered to the mesh correcting sample database, and fourth means for highlighting the retrieved partial mesh on a display device.

### TECHNICAL FIELD

The present invention relates to analysis mesh manufacturing equipment and an analysis mesh manufacturing method, which manufacture a mesh by using a CAE (Computer Aided Engineering) system that numerically simulates a physical phenomenon by numerical analysis using a calculator.

### BACKGROUND ART

As means for phenomenon clarification and problem solution, numerical simulation by a finite element method is widely used. To perform the simulation by the finite element method (hereinafter, called analysis), an analysis model is required to be manufactured. With the sustainable improvement in computer processing ability and analyzing technique, the size increase and refinement of the analysis model have advanced, and are expected to advance more and more in the future. Since the quality of the mesh of the analysis model significantly influences analysis precision, it is important to determine the index of the mesh quality to manufacture the mesh therealong. From these situations, the load of the operation of manufacturing the analysis model increases, which becomes a problem in enhancing the efficiency of analysis exploitation.

The following conventional techniques for automatically manufacturing the mesh of the analysis model are known. The first technique is illustrated in Patent Literature 1, and is a system that automatically manufactures, with respect to an input figure, a square mesh in which the sides of the square elements are aligned along the possible limit boundary thereof.

The second technique is illustrated in Patent Literature 2, and inputs a shape targeted for manufacturing a mesh to generate a plurality of types of bubbles in the region of the shape. The bubbles are moved by the force between the bubbles defined according to a predetermined law, and the number of the bubbles is then adjusted so as to arrange the adjacent relationship between the bubbles, thereby determining the stable arrangement of the bubbles. Then, the centers of the bubbles of the specified type among the plurality of types of bubbles are connected to manufacture the mesh.

The third technique is illustrated in Patent Literature 3, and is a system in which CAD data and mesh data in partial shape are registered to a sample database and input CAD data in new design shape and the sample CAD data are compared. When the input CAD data in new design shape and the sample CAD data are in partial similar shape, the sample mesh data corresponding to the sample CAD data is diverted. In addition, a mesh is manufactured with respect to the portion that is not similar to the sample data by using the existing mesh manufacturing method, and is then combined with the diverted mesh, thereby manufacturing a mesh corresponding to the new design shape.

In addition, in the conventional technique illustrated in, for example, Patent Literature 4 by which the portion that does not satisfy the quality thereof is retrieved to improve the quality thereof by a predetermined method, collapse is avoided by correcting the node on the surface of a three-dimensional mesh including a collapsing element.

### CITATION LIST

### Patent Literature

Patent Literature 1: Japanese Unexamined Patent Application Publication No. Hei 8-138082

Patent Literature 2: Japanese Unexamined Patent Application Publication No. Hei 11-110586

Patent Literature 3: WO2015/092842

Patent Literature 4: Japanese Unexamined Patent Application Publication No. Hei 10-289257

### SUMMARY OF INVENTION

### Technical Problem

However, the above conventional techniques have the following problems.

According to the conventional techniques described in Patent Literatures 1 and 2, although the mesh can be automatically manufactured, securing the quality (mesh specification), such as the shape, inner angle, and edge length of the mesh, is sometimes difficult. In the shape to be analyzed, the portion that significantly influences analysis precision and the portion that does not significantly influence analysis precision are present, so that the mesh to be manufactured is not uniform. Therefore, the mesh is manufactured by designating a parameter, such as mesh size and quality, to each portion. However, the number of processes increases.

In Patent Literature 3, although the existing mesh can be reused by portion, the partial shape thereof is required to have a characteristic shape. For example, in the case of a simple shape, such as a cylindrical surface and a torus surface, like a bead shape and a fillet shape, there are an infinite number of portions that are determined to be in partial similar shape. Consequently, this conventional technique is not practical.

In addition, in Patent Literature 4, although the mesh having poor quality can be corrected, the index of the mesh specification is required to be clearly defined. However, the element to be corrected is sometimes determined empirically and sensuously, so that in many cases, the index cannot be defined. For example, by element, even the element having good quality that is close to a regular polygon or a regular polyhedron is sometimes required to be corrected according to the connection pattern thereof. Consequently, it is difficult to quantify the index, with such the element as the element that is required to be corrected.

Although it is also considered that with respect to a collection of elements (partial mesh), the index of the portion to be corrected is defined by using the quality of each element and the connection pattern thereof, the index becomes very complicated. Consequently, a large number of processes are required for defining the index and for developing means for retrieving the portion to be corrected based on the index.

Also, this difficulty increases when it is considered that the mesh specification required is different for each portion, which is pointed as the problem of Patent Literatures 1 and 2. Further, the mesh specification is changed with the advancement of the analyzing technique and the improvement in the calculator ability. That is, the means for retrieving the portion to be corrected is required to be permanently improved, which is not preferable.

The present invention has been made in view of the above circumstances, and an object of the present invention is to provide analysis mesh manufacturing equipment and an analysis mesh manufacturing method, which are capable of manufacturing a mesh satisfying the specification thereof in consideration of the differing of the specification of the mesh to be manufactured for each portion to be analyzed, the difficulty in defining the mesh specification, and the response to the change in the mesh specification.

### Solution to Problem

To solve the above problems, for example, the configurations described in the claims are adopted.

The present invention includes a plurality of means for solving the above problems, and provides, as an example, analysis mesh manufacturing equipment having first means for registering, as an uncorrected sample, a combination of partial mesh data for a correction examining portion and CAD data associated therewith to a mesh correcting sample database, second means for storing mesh data and CAD data that are to be inspected, third means for retrieving, with respect to the mesh data and the CAD data that are to be inspected, a partial mesh that is similar to the mesh data and the CAD data of the uncorrected sample that are registered to the mesh correcting sample database, and fourth means for highlighting the retrieved partial mesh on a display device.

Further, the present invention provides analysis mesh manufacturing equipment including a display device, wherein the analysis mesh manufacturing equipment compares mesh data of an inspection target model with partial mesh data for the correction examining portion of part of the inspection target model, and retrieves a partial mesh that is similar to the mesh data for the inspection target model, and wherein the partial mesh that is retrieved as being similar to the mesh data for the inspection target model is plotted and displayed on the display device.

Further, the present invention provides analysis mesh manufacturing equipment including a display device, wherein the analysis mesh manufacturing equipment has mesh data of an inspection target model, uncorrected partial mesh data for the correction examining portion of part of the inspection target model, and corrected partial mesh data for the correction examining portion of part of the inspection target model, compares the mesh data of the inspection target model with the uncorrected partial mesh data, retrieves an uncorrected partial mesh that is similar to the mesh data for the inspection target model, and replaces the mesh data of the portion that is determined to be similar of the mesh data of the inspection target model with the corrected partial mesh data, and wherein the partial mesh that is retrieved as being similar to the mesh data for the inspection target model, the uncorrected partial mesh, and the corrected partial mesh are plotted and displayed on the display device.

Still further, an analysis mesh manufacturing method of the present invention includes storing mesh data of an inspection target model and partial mesh data for a correction examining portion of part of the inspection target model, and comparing the mesh data of the inspection target model with the partial mesh data for the correction examining portion of part of the inspection target model to retrieve a partial mesh that is similar to the mesh data for the inspection target model.

Moreover, an analysis mesh manufacturing method of the present invention includes storing mesh data of an inspection target model, uncorrected partial mesh data for the correction examining portion of part of the inspection target model, and corrected partial mesh data for the correction examining portion of part of the inspection target model, and comparing the mesh data of the inspection target model with the uncorrected partial mesh data, retrieving an uncorrected partial mesh that is similar to the mesh data for the inspection target model, and replacing the mesh data of the portion that is determined to be similar of the mesh data of the inspection target model with the corrected partial mesh data.

### Advantageous Effects of Invention

According to the present invention, the partial mesh can be registered as the sample, and from the similarity to the mesh, the partial mesh that is required to be corrected can be retrieved. Therefore, the mesh specification is not required to be quantified, thereby enhancing efficiency.

In addition, according to the embodiments of the present invention, even when the mesh specification is changed, the sample mesh is simply replaced. Therefore, the means for retrieving the portion to be corrected is not required to be permanently improved. Also, both of the similarity of the CAD data associated with the mesh and the similarity of the mesh data are evaluated. It is thus possible to respond to the differing of the specification of the mesh that is required to be manufactured for each portion.

### BRIEF DESCRIPTION OF DRAWINGS

FIG. 1 is a diagram illustrating the configuration of mesh manufacturing equipment according to a first embodiment that presents the information of a correction examining portion to the user.

FIG. 2 is a diagram illustrating inspection target model data D1 and mesh correcting sample data D2.

FIG. 3 is a diagram in which a corrected sample mesh D3 is added to FIG. 2.

FIG. 4 is a diagram illustrating the configuration of mesh manufacturing equipment according to a second embodiment that performs actual correction in addition to presenting the information of a correction examining portion to the user.

FIG. 5 is a diagram illustrating the corrected state of the inspection target model data D1 in FIG. 3.

FIG. 6 is a diagram illustrating another case of the inspection target model data D1, the mesh correcting sample data D2, and the corrected sample mesh D3.

FIG. 7 is a diagram illustrating the corrected state of the inspection target model data D1 in FIG. 6.

FIG. 8 is a diagram illustrating an example of the operation screen of a display device 100.

### DESCRIPTION OF EMBODIMENTS

Hereinafter, an example of mesh manufacturing equipment of the present invention will be described with reference to the drawings. It is noted that as the use forms of the mesh manufacturing equipment of the present invention, there are a case of only presenting the information of a correction examining portion to the user to leave actual correction to the user and a case of performing correction in addition to presenting the information of a correction examining portion to the user. Therefore, hereinbelow, the former form is represented as a first embodiment, and the latter form is represented as a second embodiment.

### First Embodiment

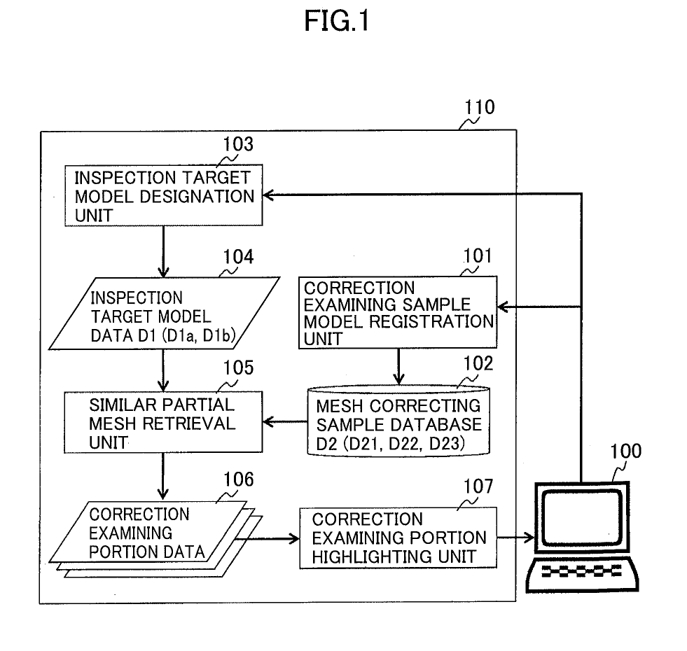

FIG. 1 is a diagram illustrating the configuration of mesh manufacturing equipment according to a first embodiment that presents the information of a correction examining portion to the user.

The configuration of FIG. 1 is achieved by calculator equipment including CAD, and in FIG. 1, the inside of calculator equipment 110 is described as specific process functions. In FIG. 1, the reference numeral 100 denotes a display device connected to input means, such as a keyboard, and a process intended by the user and information presentation are given from here to the calculator equipment 110. The calculator equipment 110 displays various process results on the screen of the display device 100.

In addition, in FIG. 1 102 denotes a so-called database, 104 and 106 denote data storage units, such as RAMs, temporarily storing computation results, and others are various process functions achieved by the computation unit of the calculator equipment 110.

An example of a process procedure according to the present invention will be described below, and here, two types of mesh data are handled. One of the mesh data is data D1 that represents the whole of a model to be inspected (inspection target model data), and the other mesh data is sample data D2 for the correction of part of the inspection target model data D1 (mesh correcting sample data).

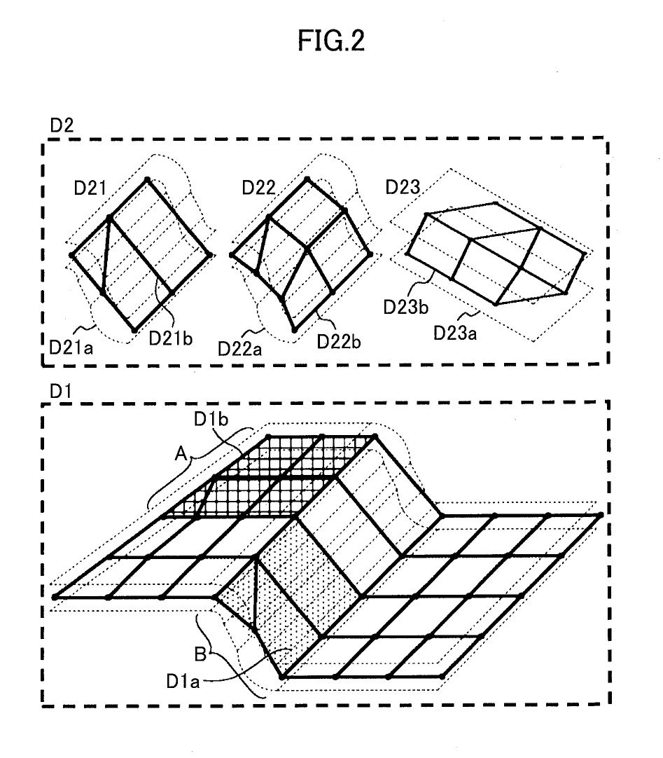

FIG. 2 illustrates the inspection target model data D1 and the mesh correcting sample data D2. First, in the inspection target model data D1, D1a indicated by dotted lines is data from CAD, and shows a shape plotted by smooth curved lines. D1b indicated by solid lines is data in mesh shape in which the curved shape of the D1a is simulated as a mesh by straight lines.

The inspection target model data D1 represents the whole model, and the mesh shape thereof includes the portion that should be corrected in performing analysis. Three examples of such the portion to be corrected are illustrated as the mesh correcting sample data D2 in FIG. 2. The mesh correcting sample data D2 also includes data from CAD indicated by curved dotted lines (D21a, D22a, D23a), and data in mesh shape indicated by straight solid lines (D21b, D22b, D23b). It is noted that in the illustrated example, the inspection target model data D1 includes two portions that should be corrected and correspond to mesh correcting sample data D21. The portions to be corrected are displayed in light black.

In FIG. 1, the inspection target model data D1 is given to an inspection target model designation unit 103 in the calculator equipment 110 by using the display device 100 connected to the input means, such as a keyboard. The inspection target model designation unit 103 includes means for designating a pair of the mesh data D1b to be inspected and the CAD data D1a corresponding thereto. The mesh data D1b and the CAD data D1a that are designated here are registered onto, for example, the RAM as the inspection target model data storage unit 104.

In addition, in FIG. 1, the mesh correcting sample data D2 (D21, D22, D23) is given to a correction examining sample model registration unit 101 in the calculator equipment 110 by using the display device 100 connected to the input means such as a keyboard. The correction examining sample model registration unit 101 includes means for designating, as the correction examining portion, a pair of partial mesh data (D21b, D22b, D23b) and partial CAD data (D21a, D22a, D23a) corresponding thereto. The partial mesh data and the partial CAD data that are designated here are registered as an uncorrected sample model to the mesh correcting sample database 102.

A pair of partial mesh data and partial CAD data is registered as the uncorrected sample model to the mesh correcting sample database 102. In addition, a pair of the uncorrected sample model and corrected partial mesh data associated therewith is also registered as a corrected sample model, which will be described later.

A similar partial mesh retrieval unit 105 registers, with respect to the inspection target model data storage unit 104 (data D1), as the correction examining portion data storage unit 106, a partial mesh that is similar to the mesh data (D21b, D22b, D23b) and the CAD data (D21a, D22a, D23a) of the uncorrected sample model that are registered to the mesh correcting sample database 102. In the case of FIG. 2, the two portions of the D1 in light black that correspond to the mesh data D21b of the uncorrected sample model are extracted and registered.

It is noted that for a method for specifically achieving the process here, it is possible to apply, as a method for evaluating the similarity of CAD data, for example, techniques disclosed in “Hongshen Wang, Lin Zhang and Yonggui Zhang, “Partial Matching of 3D CAD Models with Attribute Graph”, Applied Mechanics and Materials, Vol. 528 (2014), pp. 302-309”, and “Makoto Onodera et al., “Development of similar sub-part recognition technique for 3D-CAD Model described by boundary representation”, The Japan Society of Mechanical Engineers, The Proceedings of the 25th Design & Systems Conference (2015)”.

In these methods, whether CAD data in partial shape that is designated by a retrieval key is included in CAD data to be retrieved is quantified by an index of similarity. In addition, the similarity is the weighted average of the similarity of each structure geometric shape (surface and line) of CAD data. It is noted that the similarity of each structure geometric shape is calculated based on geometric information, such as an area, a line length, a surface type (a plane, a cylindrical surface, and a free-form curved surface), and a curvature. This method is a method for determining whether CAD data in partial shape is included in CAD data to be retrieved.

As a method for evaluating the similarity of mesh data, for example, the method for evaluating the similarity of CAD data is applied. The similarity of mesh data is evaluated by the weighted average of the similarity of each structure element of the mesh data. The similarity of each structure element is calculated based on element information, such as a volume, an area, an element type (a triangle, a square, a tetrahedron, and a hexahedron), an element normal line, and the distance between nodes. With this, like the similarity of CAD data, the similarity of mesh data can be evaluated.

A correction examining portion highlighting unit 107 configures the display screen of the display device 100 by highlighting, with respect to the mesh data to be inspected, the partial mesh that is registered to the correction examining portion data storage unit 106.

A specific process case will be described below with reference to the drawings. In this case, a case of manufacturing a neutral shell mesh at the middle of a thin plate structure will be described as an example.

First, pairs (D21b and D21a, D22b and D22a, and D23b and D23a) of three partial meshes (D21b, D22b, and D23b) and partial CAD (D21a, D22a, and D23a) that are represented in the D2 are registered as the uncorrected sample model to the mesh correcting sample database 102 in FIG. 1. In addition, the model represented in the D1 (mesh D1b and CAD D1a) is designated as the inspection target model data storage unit 104. It is noted that in this example, the element edges of the mesh data are indicated by solid lines, and the ridges of the CAD data are indicated by dashed lines.

Then, the similar partial mesh retrieval unit 105 retrieves a similar partial mesh in such a manner that the data D1 of the inspection target model data storage unit 104 is to be inspected and that the data D2 of the uncorrected sample model of the mesh correcting sample database 102 (D21, D22, D23) is a retrieval key. As a result, dot hatchings A and B of the partial mesh D1a are determined to be similar to the uncorrected sample model D21, and are then registered to the correction examining portion data storage unit 106.

Then, the correction examining portion highlighting unit 107 highlights the partial mesh D2 of the correction examining portion data storage unit 106 with respect to the inspection target model data D1 on the display device 100. As the highlighting means, a method by changing the color of only the partial mesh D2 of the correction examining portion data storage unit 106 for display and a method by changing the transparent degree of the mesh other than the partial mesh D2 of the correction examining portion data storage unit 106 for display are used.

For the contents displayed on the display device 100 as the result of the above process, the partial mesh that is retrieved as being similar to the mesh data for the inspection target model is plotted and displayed. And, the similar portion of the mesh data for the inspection target model is highlighted.

In this way, the partial mesh D2 can be registered as the sample, and from the similarity to the mesh D2, the partial mesh that is required to be corrected can be retrieved. Therefore, the mesh specification is not required to be quantified, thereby enhancing efficiency.

In addition, the similarity of the CAD data associated with the mesh is evaluated. Therefore, excessive detection can be prevented. For example, in the example of FIG. 2, the two cross hatchings A and B are similarity-determined. The partial mesh represented in the cross hatching A is similar to the mesh data of the uncorrected sample model D22. On the contrary, the CAD data is not similar because the CAD data on the inspection target model side includes a plane and the CAD data of the uncorrected sample model includes a plurality of cylindrical surfaces and planes. Therefore, the cross hatching A is not hit in retrieval. In this way, only the portion in which the similarity of the CAD and the similarity of the mesh are both high is retrieved. It is thus possible to respond to the differing of the specification of the mesh that is required to be manufactured for each portion.

By a series of processes illustrated in FIG. 1, the user can easily grasp the correction examining portion for the inspection target model data D1. Typically, when the inspection target model data D1 includes a large model or a model in complicated shape, and on the other hand, when there are a large number of correction examining portions, the specific correction examining portion can be made visible and grasped on the inspection target model data D1 by the first embodiment of the present invention. This enables significant time reduction in performing later processes.

The mesh manufacturing equipment that has been described above as the first embodiment includes the correction examining sample model registration unit 101 registering, as the uncorrected sample model, the partial mesh data for the correction examining portion and the CAD data associated therewith to the mesh correcting sample database 102, the inspection target model designation unit 103 designating the inspection target model data storage unit 104 including the mesh data and the CAD data that are to be inspected, the similar partial mesh retrieval unit 105 registering, with respect to the inspection target model data storage unit 104, as the correction examining portion data, the partial mesh that is similar to the mesh data and the CAD data of the uncorrected sample model that are registered to the mesh correcting sample database 102, and the correction examining portion highlighting unit 107 highlighting the correction examining portion data storage unit 106.

### Second Embodiment

In a second embodiment, a case of performing actual correction in addition to presenting the information of the correction examining portion to the user will be described.

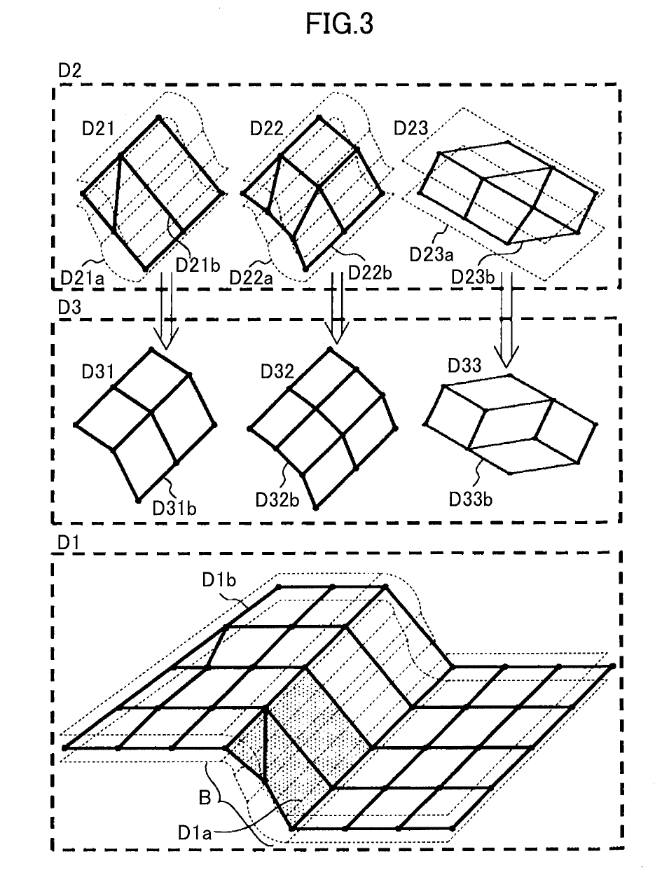

In the second embodiment, since the portion to be corrected is automatically corrected, the finding in FIG. 3 is further held to be used for correction.

FIG. 3 additionally displays, as D3, the information of the finding about the correction in FIG. 2. This is the finding in which the D21 should be corrected to D31, the D22 should be corrected to D32, and the D23 should be corrected to D33. For example, when the finding in which the D21 and D22 each include a triangular portion in the shape sectioned by the mesh but should be simulated in, for example, square shape in strength is obtained, the D21 and D22 should be respectively replaced with (or corrected to) the D31 and D32 in mesh shape including a square only.

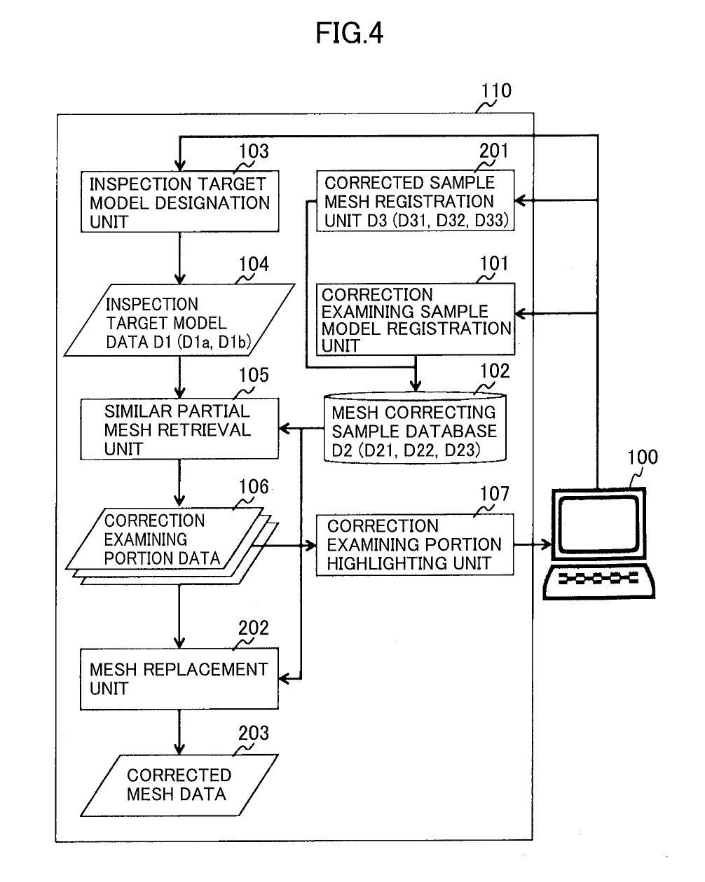

FIG. 4 is a diagram illustrating the configuration of mesh manufacturing equipment according to the second embodiment that performs actual correction in addition to presenting the information of the correction examining portion to the user. In FIG. 4, the mesh manufacturing equipment including a correcting function is further configured as below. First, a corrected sample mesh registration unit 201 is newly added, and the corrected sample mesh registration unit 201 includes means for designating the corrected sample mesh D3 corresponding to the uncorrected sample model. The corrected sample mesh D3 that is designated here is associated with the uncorrected sample model D2, and is registered to the mesh correcting sample database 102. For example, for preparation, the D31 is associated with the D21, the D32 is associated with the D22, and the D33 is associated with the D23.

In the first embodiment in FIG. 1, the detected correction examining portion is only displayed on the display device, whereas in the second embodiment in FIG. 4, the correction thereof is successively executed. A mesh replacement unit 202 replaces the correction examining portion data D2 that is retrieved as being similar to the uncorrected sample model D2 with the corrected sample mesh D3 corresponding thereto, which is then registered as corrected mesh data 203.

In a representative replacing method, a coordinate transform matrix so that the normal lines and coordinates of the structure geometric shapes in similar correspondence relationship are matched is determined, the coordinate transform matrix is applied to the corresponding corrected sample mesh, and coordinate transformation is performed. Thereafter, with respect to the inspection target model data storage unit 104, the partial mesh for the correction examining portion data D2 is deleted, and the corrected sample mesh D3 that is subjected to positioning node movement is then added. It is noted that when the number of nodes of the boundary of the correction examining portion data D2 and the number of nodes of the boundary of the corrected sample mesh D3 are different, a node addition or deletion process is performed with respect to the boundary of the correction examining portion data D2. Further, a one-to-one correspondence relationship is determined with respect to the nodes of the boundaries based on an index, such as a distance, and the nodes in the correspondence relationship are then connected.

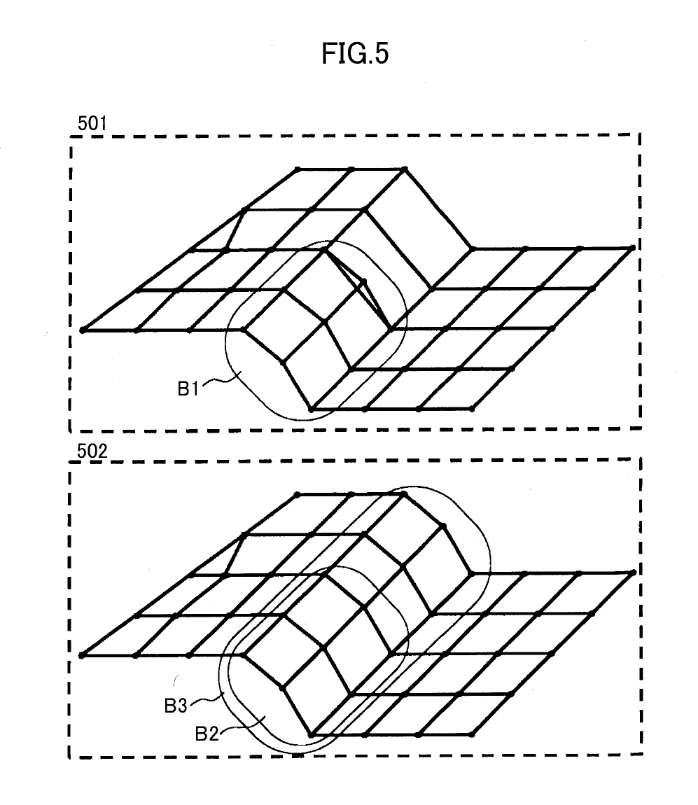

Successively, an example of the procedure of the mesh correction process and the flow of data in which the analysis mesh manufacturing equipment according to the second embodiment of the present invention is used will be described with reference to FIGS. 3 and 5. It is noted that FIG. 5 is a diagram illustrating the corrected state of the inspection target model data D1 in FIG. 3.

In FIG. 3, first, corresponding to the uncorrected sample model D2 shown in the D21 to D23, the corrected sample mesh D3 of the D31 to D33 is registered to the mesh correcting sample database 102. In addition, it is determined by the similar partial mesh retrieval unit 105 that the partial mesh that is represented in the dot hatching B of the whole model D3 that is stored in the inspection target model data storage unit 104 is similar to the uncorrected sample model D21, and the partial mesh is then registered to the correction examining portion data storage unit 106.

Successively, the mesh replacement unit 202 determines a coordinate transform matrix so that the normal lines and coordinates of the structure geometric shapes in similar correspondence relationship are matched, applies the coordinate transform matrix to the corrected sample mesh D31 corresponding to the uncorrected sample model D21, and performs coordinate transformation. Thereafter, with respect to the inspection target model data D3, the partial mesh of the dot hatching B that is the correction examining portion data is deleted, and a mesh that is coordinate-transformed with respect to the corrected sample mesh represented in the D31 is then added.

A state where the portion of the dot hatching B of the whole model D3 in FIG. 3 is replaced with the corrected sample mesh D31 for coordinate transformation is represented as B1 of 501 in FIG. 5. From this, when the shape of the portion of the B1 is compared with the shape of the dot hatching B that is the correction examining portion data before correction, the number of nodes of the boundary of the dot hatching B is different from the number of nodes of the boundary of the corrected sample mesh. Therefore, node addition is subjected to the boundary of the dot hatching B that is the correction examining portion data, and the related element is then subdivided. B2 of 502 in FIG. 5 represents a state where node addition is subjected to the boundary of the dot hatching B.

Further, a one-to-one correspondence relationship is determined with respect to the nodes of the boundaries of the B1 and the dot hatching B based on an index, such as a distance, and the nodes in the correspondence relationship are then connected. This result is finally obtained as the analysis mesh that is represented in 502 in FIG. 5. By the correction of the corresponding portion, the range of change is finally extended to B3. It is noted that although in this example, the method for sequentially extending the element edges for division toward the opposite sides is adopted as the subdivision of the element, a method for subdividing only the element without extending the element can also be selected.

In this way, the corrected sample mesh is also managed by the mesh correcting sample database 102. Therefore, the mesh correction can be automated. In addition, even when the mesh specification is changed, the sample mesh is simply replaced. Therefore, the means for retrieving the portion to be corrected is not required to be permanently improved.

The analysis mesh manufacturing equipment that has been described above as the second embodiment includes the corrected sample mesh registration unit 201 registering, as the corrected sample model, the corrected partial mesh data associated with the uncorrected sample model to the mesh correcting sample database 102, and the mesh replacement unit 202 replacing the correction examining portion data storage unit 106 that is retrieved as being similar to the uncorrected sample model, with the corrected sample model corresponding thereto, and registering the corrected sample model as the corrected mesh data 203.

### Third Embodiment

In a third embodiment, another case of the analysis process procedure of the analysis mesh manufacturing equipment according to the present invention will be described.

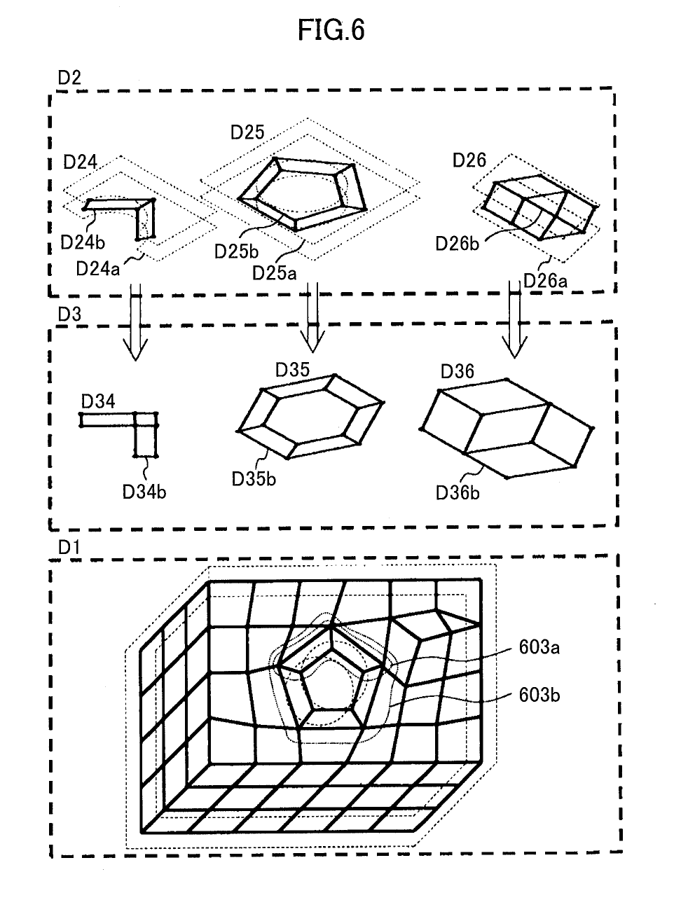

First, FIG. 6 is a diagram illustrating another case of the inspection target model data D1, the mesh correcting sample data D2, and the corrected sample mesh D3, and corresponding to FIG. 3.

First, pairs (D24b and D24a, D25b and D25a, and D26b and D26a) of three partial meshes D2b (the D24b, the D25b, and the D26b) and partial CAD D2a (the D24a, the D25a, and the D26a) that are respectively represented in the D2 (D24, D25, and D26) are registered as the uncorrected sample model of the mesh correcting sample database 102. In addition, corrected sample meshes D34, D35, and D36 that respectively correspond to the uncorrected sample models D24, D25, and D26 are registered to the mesh correcting sample database 102. Further, the inspection target model D1 (mesh D1a and CAD D1b) is designated to the inspection target model data storage unit 104.

Then, the similar partial mesh retrieval unit 105 retrieves a similar partial mesh in such a manner that the inspection target model data D1 (mesh D1a and CAD D1b) is to be inspected and that the uncorrected sample model D2 (D24, D25, D26) is a retrieval key. As a result, a partial mesh 603a is determined to be similar to the uncorrected sample model D24. In addition, a partial mesh 603b is determined to be similar to the uncorrected sample model D25. These two partial meshes are then registered as the correction examining portion data storage unit 106.

Then, since the same element is similarity-retrieved as the correction examining portion data from the plurality of types of uncorrected samples (D24 and D25), the mesh replacement unit 202 designates to which uncorrected sample the corrected sample mesh to be adopted correspond.

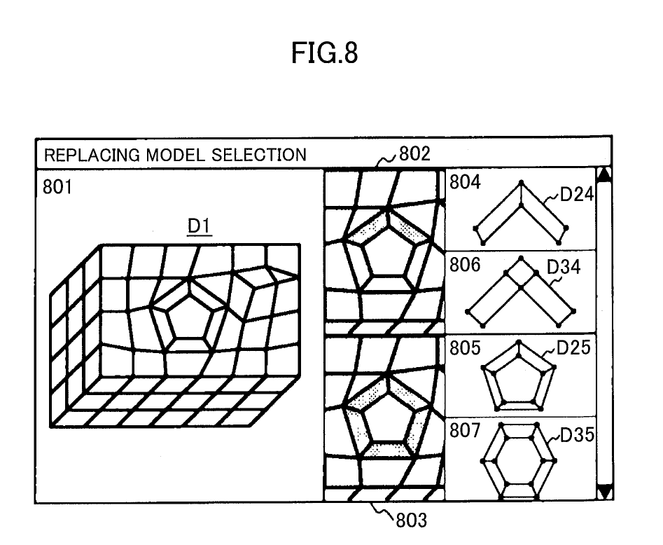

An example of the operation screen of the display device 100 in this case is illustrated in FIG. 8. The whole model D1 is displayed in an area 801 of the operation screen, and the target element portions that are stored in the correction examining portion data storage unit 106 are highlighted in areas 802 and 803. The target element portion that is similarity-extracted as two sides of the pentagon is displayed in the area 802, and the target element portion that is similarity-extracted as the pentagon is displayed in the area 803. Further, the uncorrected sample model D24 is displayed in an area 804, the uncorrected sample model D25 is displayed in an area 805, the corrected sample mesh D34 is displayed in an area 806, and the corrected sample mesh D35 is displayed in an area 807.

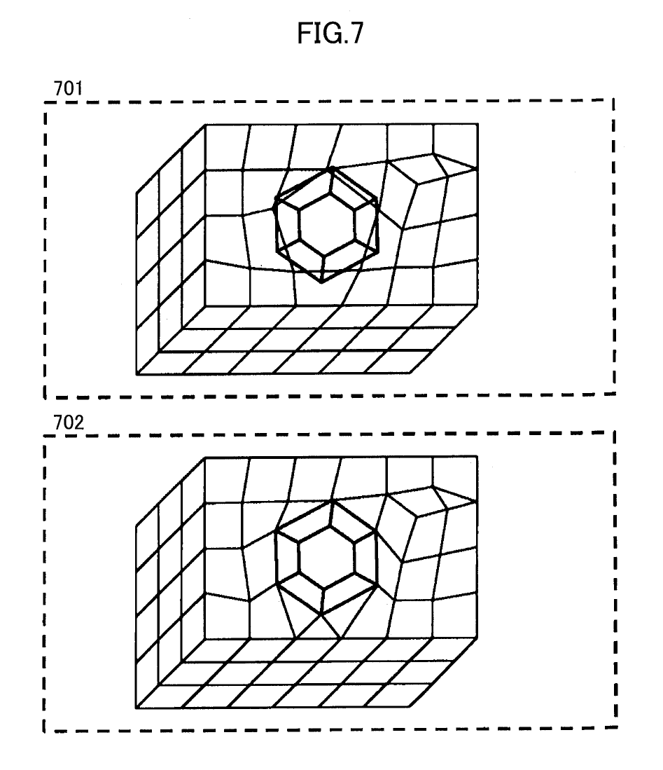

The user of this equipment selects the corrected sample mesh to be adopted from this screen. In this example, the corrected sample mesh D35 corresponding to the uncorrected sample model D25 is selected. The mesh replacement unit 202 determines a coordinate transform matrix so that the normal lines and coordinates of the structure geometric shapes in similar correspondence relationship are matched, applies the coordinate transform matrix to the corresponding corrected sample mesh, and performs coordinate transformation. Thereafter, in the inspection target model D1, the partial mesh of the correction examining portion data represented in the 603b is deleted, and a mesh that is subjected to positioning node movement with respect to the corrected sample mesh D35 is added to this position. With this, the analysis mesh represented in 701 in FIG. 7 is obtained.

In this case, the number of nodes of the boundary of the correction examining portion data 603b and the number of nodes of the boundary of the corrected sample mesh D35 are different. Therefore, node addition is subjected to the boundary of the correction examining portion data 603b, and the related element is then subdivided. Further, a one-to-one correspondence relationship is determined with respect to the nodes of the boundaries based on an index such as a distance, and the nodes in the correspondence relationship are then connected. As a result, the analysis mesh represented in 702 in FIG. 7 is obtained. It is noted that in the previously illustrated example, the subdivision of the element is extended toward the opposite sides, but in this example, only the element is subdivided.

In this way, the partial mesh can be registered as the sample, and from the similarity to the mesh, the partial mesh that is required to be corrected can be retrieved. Therefore, the mesh specification is not required to be quantified, thereby enhancing efficiency.

In addition, even when the mesh specification is changed, the sample mesh is simply replaced. Therefore, the means for retrieving the portion to be corrected is not required to be permanently improved. Further, both of the similarity of the CAD data associated with the mesh and the similarity of the mesh data are evaluated. It is thus possible to respond to the differing of the specification of the mesh that is required to be manufactured for each portion.

### LIST OF REFERENCE SIGNS

101: Correction examining sample model registration unit
102: Mesh correcting sample database
103: Inspection target model designation unit
104: Inspection target model data storage unit
105: Similar partial mesh retrieval unit
106: Correction examining portion data storage unit
107: Correction examining portion highlighting unit
201: Corrected sample mesh registration unit
202: Mesh replacement unit
203: Corrected mesh data storage unit

1. Analysis mesh manufacturing equipment comprising:
first means for registering, as an uncorrected sample, a combination of partial mesh data for a correction examining portion and CAD data associated therewith to a mesh correcting sample database;
second means for storing mesh data and CAD data that are to be inspected;
third means for retrieving, with respect to the mesh data and the CAD data that are to be inspected, a partial mesh that is similar to the mesh data and the CAD data of the uncorrected sample that are registered to the mesh correcting sample database; and
fourth means for highlighting the retrieved partial mesh on a display device.

2. The analysis mesh manufacturing equipment according to claim 1, further comprising:
fifth means for registering, as a corrected sample, corrected partial mesh data corresponding to the uncorrected sample; and
sixth means for replacing the partial mesh that is retrieved as being similar to the uncorrected sample with the partial mesh that is registered as the corrected sample corresponding thereto.

3. The analysis mesh manufacturing equipment according to claim 2, further comprising:
seventh means for, when there are a plurality of types of partial meshes that are retrieved as being similar to the uncorrected sample, giving priority to the partial mesh having higher similarity to replace the partial mesh having higher similarity with the partial mesh of the corrected sample corresponding to the uncorrected sample or to designate the corrected sample targeted for replacement.

4. Analysis mesh manufacturing equipment including a display device,
wherein the analysis mesh manufacturing equipment compares mesh data of an inspection target model with partial mesh data for the correction examining portion of part of the inspection target model, and retrieves a partial mesh that is similar to the mesh data for the inspection target model, and
wherein the partial mesh that is retrieved as being similar to the mesh data for the inspection target model is plotted and displayed on the display device.

5. Analysis mesh manufacturing equipment including a display device,
wherein the analysis mesh manufacturing equipment has mesh data of an inspection target model, uncorrected partial mesh data for the correction examining portion of part of the inspection target model, and corrected partial mesh data for the correction examining portion of part of the inspection target model, compares the mesh data of the inspection target model with the uncorrected partial mesh data, retrieves an uncorrected partial mesh that is similar to the mesh data for the inspection target model, and replaces the mesh data of the portion that is determined to be similar of the mesh data of the inspection target model with the corrected partial mesh data, and
wherein the partial mesh that is retrieved as being similar to the mesh data for the inspection target model, the uncorrected partial mesh, and the corrected partial mesh are plotted and displayed on the display device.

6. The analysis mesh manufacturing equipment according to claim 5,
wherein when there are a plurality of uncorrected partial meshes that are similar to the mesh data for the inspection target model, the plurality of uncorrected partial meshes that are similarity-detected are displayed on the display device, the order of replacing the mesh data of the portion that is determined to be similar with the corrected partial mesh data being capable of being selected.

7. An analysis mesh manufacturing method comprising:
storing mesh data of an inspection target model and partial mesh data for a correction examining portion of part of the inspection target model; and
comparing the mesh data of the inspection target model with the partial mesh data for the correction examining portion of part of the inspection target model to retrieve a partial mesh that is similar to the mesh data for the inspection target model.

8. An analysis mesh manufacturing method comprising:
storing mesh data of an inspection target model, uncorrected partial mesh data for the correction examining portion of part of the inspection target model, and corrected partial mesh data for the correction examining portion of part of the inspection target model; and
comparing the mesh data of the inspection target model with the uncorrected partial mesh data, retrieving an uncorrected partial mesh that is similar to the mesh data for the inspection target model, and replacing the mesh data of the portion that is determined to be similar of the mesh data of the inspection target model with the corrected partial mesh data.
